(19) United States
(12) Patent Application Publication
(10) Pub. No.: US 2001/0012528 A1
(43) Pub. Date: Aug. 9, 2001

(54) Method of producing a wafer product, assembly for implementing the method, and wafer product produced according to the method

(76) Inventors: Karl Draganitsch, Donnerskirchen (AT); Rudolf Fila, Maria Enzersdorf (AT)

Correspondence Address: LERNER AND GREENBERG, P.A., POST OFFICE BOX 2480, HOLLYWOOD, FL, 33022-2480, US

(21) Appl. No.: 09/817,573

(22) Filed: Mar. 26, 2001

Related U.S. Application Data
(63) Continuation of application No. PCT/AT99/00219, filed on Sep. 9, 1999.

(30) Foreign Application Priority Data
Oct. 1, 1998 (AT) 1633/98

(51) Int. Cl. A21D 13/00

(52) U.S. Cl. 426/94; 426/274

(57) ABSTRACT

Wafer products are produced with two or more wafer sheets and food product in between. The food product, for instance confectionery, meat, fish, cheese, fruit or vegetable product or the like, nuts, or almonds, is applied to a first wafer sheet delivered still hot from the oven. The wafer sheet contains at least 23% sugar or an identical portion of a substance with the same technological properties as sugar, such as trehalose. A second, still-hot wafer sheet is applied to the first layer, the second wafer also containing at least 23% sugar or an identical portion of a substance with the same technological properties as sugar. The two wafer sheets containing the layer of the food product are joined to each other by pressing.

### CROSS-REFERENCE TO RELATED APPLICATION

This application is a continuation of copending International Application PCT/AT99/00219, filed Sep. 9, 1999, which designated the United States.

### BACKGROUND OF THE INVENTION

1. Field of the Invention

The present invention relates to a method of producing a wafer product containing a food product using at least two wafer sheets, furthermore a unit for producing such a wafer product, and finally a wafer product produced according to this process.

Many wafer products are known which consist of wafer sheets and fillings placed between the wafer sheets, such as confections, meat products, or cheese products. Since the wafer sheets undergo a baking process, they cannot for this reason contain ingredients with vitamins, flavorings, and the like, since these ingredients would be damaged or spoiled by the baking process. Instead, conventional wafer products consist of several wafer sheets that are combined to form one product after the baking process with fillings consisting of additional food products placed between them.

As a rule, batters used to produce wafer sheets have a sugar content of approximately 3% to 5. With such a sugar content the wafer sheets are neutral in taste. Furthermore, wafer sheets with such a sugar content cannot be shaped after the baking process, but are relatively brittle even while they are still warm and therefore break during any shaping.

Furthermore, wafer batters are known with a sugar content of more than 23%. With such a sugar content, the wafer sheets can be formed after the baking process, e.g. into hollow cylindrical shapes, into which a filling, such as, for example, a chocolate mass, can be introduced. Nevertheless, the fact remains that this type of wafer product, too, cannot contain any other food products, particularly the type that causes specific taste sensations.

### SUMMARY OF THE INVENTION

The object of the present invention is to provide a wafer sheet which overcomes the above-noted deficiencies and disadvantages of the prior art devices and methods of this general kind, and which renders possible to produce a wafer sheet which triggers a wide variety of taste sensations.

With the above and other objects in view there is provided, in accordance with the invention, a method of producing a wafer product, which comprises:

outputting a first wafer sheet with a sugar content of at least 23% or an equivalent content of a substance having the same technological properties as sugar (e.g., trehalose) from a baking oven;

applying to the first wafer sheet, while the first wafer sheet is in a hot state, a layer of a food product;

providing a second wafer sheet with a sugar content of at least 23% or an equivalent content of a substance (e.g., trehalose) having the same technological properties as sugar, and placing the second wafer sheet, while the second wafer sheet is in a hot state, on the first wafer sheet; and

subsequently compressing and spatially shaping the first and second hot wafer sheets containing the layer of the food product.

The food product that is placed between the first and second wafer sheets may be a confection, meat product, fish product, cheese product, fruit product, vegetable product, nuts, and/or almonds, for instance.

In other words, the object of the invention is attained in that, onto a first still hot wafer sheet fed from the baking oven with a sugar content of at least 23%, or an identical content of a substance with the same technological properties as sugar, a layer of a food product is applied, that a second still hot wafer sheet, also having a sugar content of at least 23%, or an identical content of a substance with the same technological properties as sugar, is applied, and that subsequently the two hot wafer sheets containing the layer having a food product are combined by pressing and are spatially shaped.

A particular advantage of this process is that it allows the use of different press molds to produce wafers of any shape which contain any desired ingredients and thus any desired flavorings. This is important since in accordance with the prior art many different baking molds were required to produce differently shaped wafers, whereas the process according to the invention merely requires different press molds. This fact is of decisive importance since equipping a baking oven with different baking molds is technically complex and time-consuming while press molds located outside the baking oven can be replaced by different press molds in a short time. Since the production costs of press molds are furthermore much lower than those of baking molds, decisive cost savings are thereby achieved. Wafers which contain any desired flavorings, have been spatially shaped and serve as starting products for filled wafers are not known from the prior art.

Furthermore, the pressed-together wafer sheets can be cut into individual hollow bodies into which a filling can be subsequently introduced. In addition, these wafer products can be provided with a coating which surrounds them.

In accordance with another feature of the invention, additional hot wafer sheets may be processed together with the first and second wafer sheets and interposed layers of food products. In other words, the wafer product may be a multi-stack of several wafer sheets and food product layers.

With the above and other objects in view, there is also provided, in accordance with the invention, an assembly for producing wafer products as outlined above. The assembly comprises the following elements:

an baking oven outputting hot wafer sheets;

a conveyor device adjacent the baking oven;

a lifting device for lifting a respective first wafer sheet of a pair of hot wafer sheets from the conveyor device;

a dosing device for depositing a food product onto a respective second wafer sheet of the pair of hot wafer sheets; and

a processing device disposed to receive the pair of hot wafer sheets for pressing and shaping the two superimposed hot wafer sheets containing the layer of food product.

In other words, the assembly for producing wafer sheets has an automatically controlled baking oven and a conveyor device. A lifting device is configured for lifting a respective first wafer sheet of a pair of wafer sheets, furthermore a dosing device for applying a food product to the respective second wafer sheet, and a device for pressing and spatially shaping the two superimposed hot wafer sheets containing a layer of a food product. The press device can be designed as a shaping device. Furthermore, the shaping device may be formed by a suction device.

Preferably, a separation device, particularly a stamping device, is furthermore provided to enable the combined wafer sheets to be separated into individual hollow bodies.

Utilizing trehalose instead of sugar also allows the wafer sheets to be shaped in the warm state.

The invention also provides for a wafer product, comprising a plurality of wafer sheets and intermediate layers of a food product disposed between respective the wafer sheets, combined by pressing and spatially shaped into individual wafer product.

Other features which are considered as characteristic for the invention are set forth in the appended claims.

Although the invention is illustrated and described herein as embodied in a process for producing a wafer product, an assembly for implementing the process, and a wafer product produced according to the process, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is an axonometric view of an assembly for producing a wafer product according to the invention;

FIG. 2 is an axonometric view of a first workstation of the assembly, a second workstation, and a third workstation, with the third workstation in a first operating position;

FIG. 3 is a similar view, with the third workstation of the assembly in a second operating position;

FIG. 4 is a similar view, with the third workstation of the assembly in a third operating position;

FIG. 5 is a diagrammatic side view of a fourth workstation of the assembly in a schematic side view;

FIGS. 5a and 5b are diagrammatic side views of variant embodiments of the fourth workstation; and

FIG. 6 is a diagrammatic side view of a fifth workstation of the assembly.

### DESCRIPTION OF THE PREFERRED EMBODIMENTS

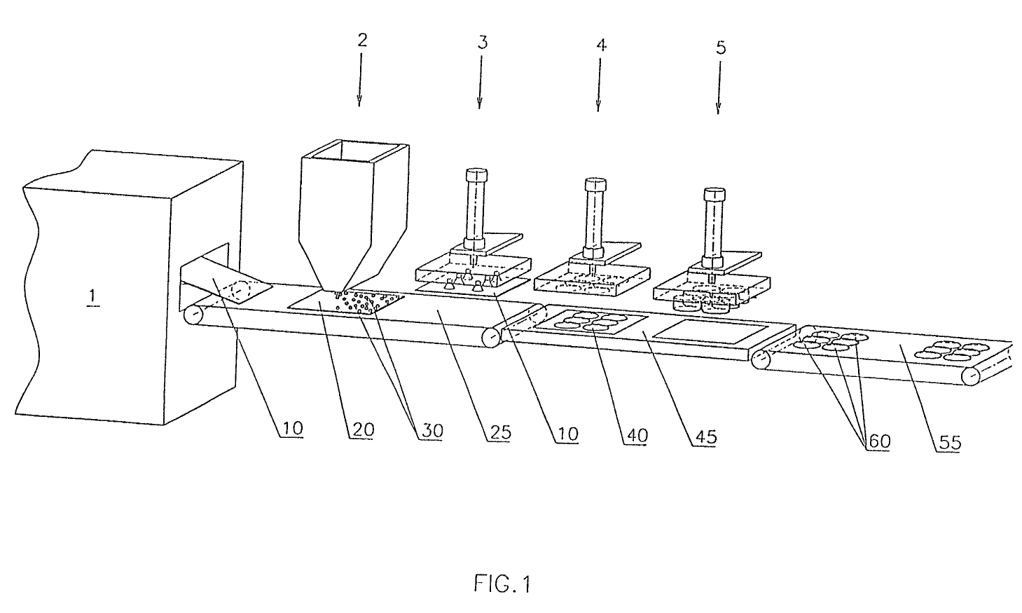

Referring now to the figures of the drawing in detail and first, particularly, to FIG. 1 thereof, there is seen a unit for producing a wafer sheet. The unit is comprised of a first workstation formed by an automatically controlled baking oven 1 for producing wafer sheets 10 and 20; furthermore of a second workstation 2 in which a food product 30 is applied to a second wafer sheet 20 in each case; of a third workstation 3 in which the two wafer sheets 10 and 20 are placed one on top of the other; of a fourth workstation 4 in which the two superimposed wafer sheets 40 are pressed together; and of a fifth workstation 5 in which the wafer sheets that have been pressed together and have possibly been shaped are separated into individual products 60. Conveyor belts 25 and 45 are assigned to workstations 2, 3, 4 and 5.

From the fifth workstation 5, wafer sheets 60 are discharged by a conveyor device 55 and are supplied to further processing and subsequently to packaging.

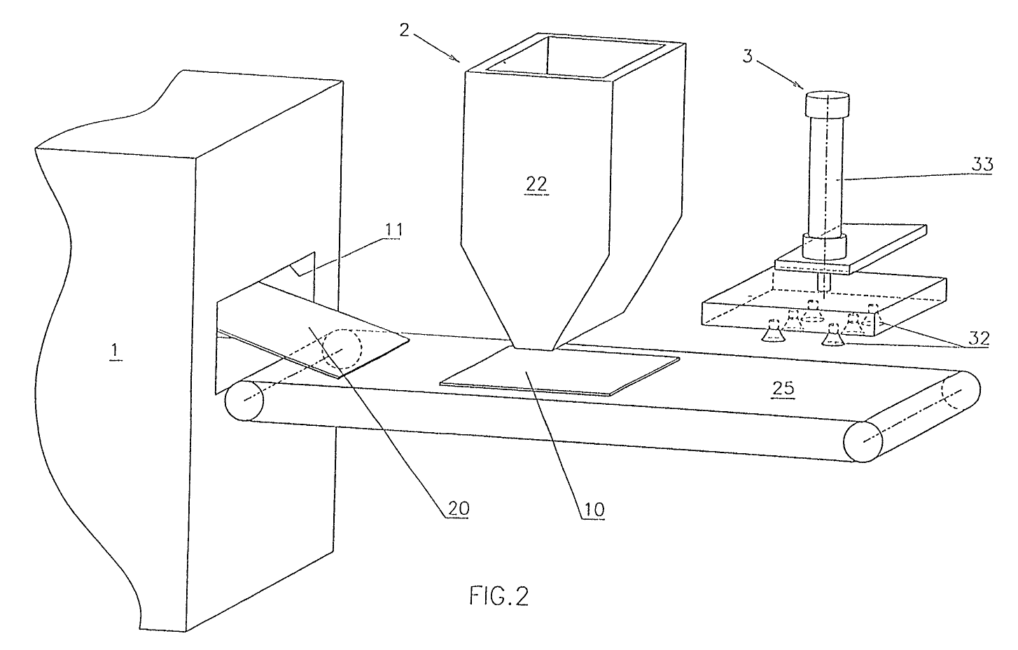

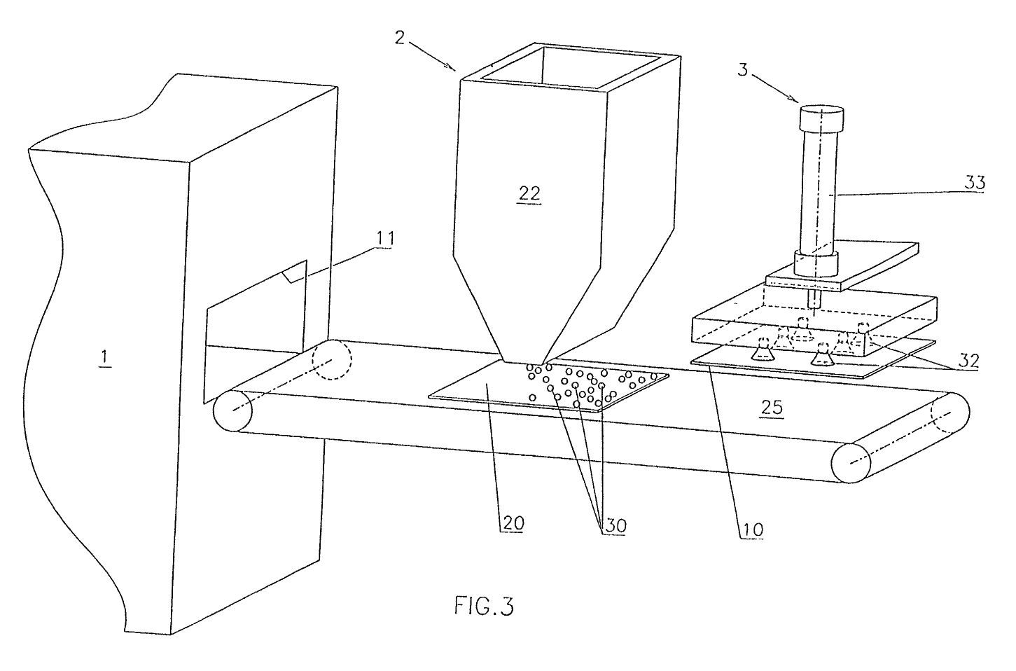

Referring now more specifically to FIGS. 2 and 3, the automatically controlled baking oven 1, through an output opening 11, successively feeds first and second wafer sheets 10 and 20 to the conveyor belt 25 assigned to the second workstation 2 and the third workstation 3. The respective first wafer sheet 10 of a pair of wafer sheets 10 and 20 is transported by the conveyor belt 25 underneath a dosing device 22 or metering device through to the third workstation 3. The latter is a lifting device, where the sheet is lifted, for example, by means of suction cups 32 whose height can be adjusted by an actuator 33. At the same time, the respective second wafer sheet 20 is transported underneath the dosing device 22, which coats it with a food product 30, e.g. a confection, meat product, fish product, cheese product, fruit product, vegetable product or the like, or with nuts or almonds.

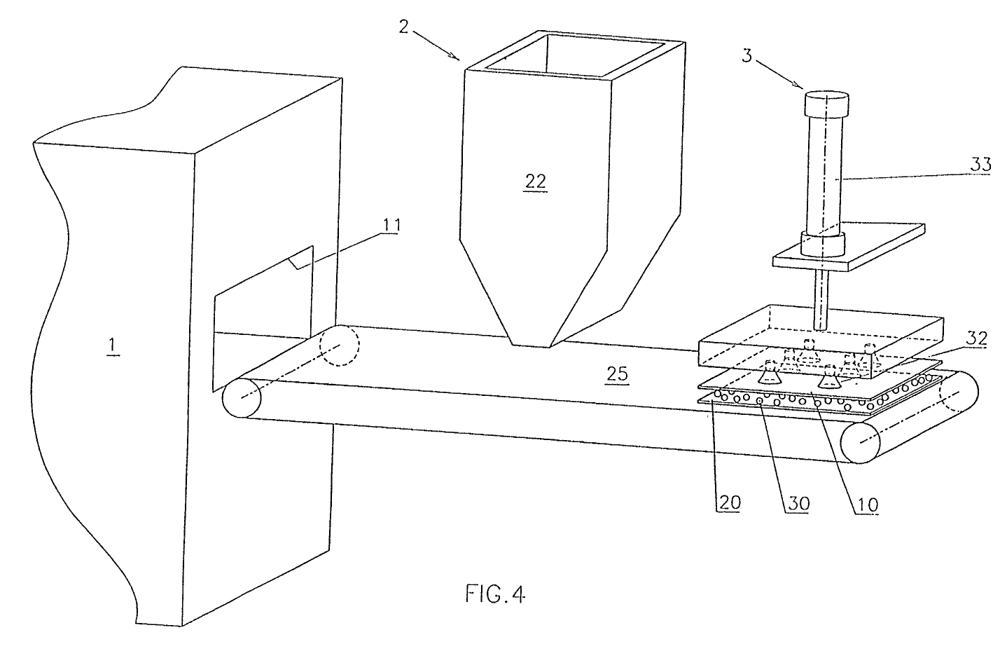

Subsequently, the conveyor belt 25 transports the second wafer sheet 20 coated with the food product 30 underneath the first wafer sheet 10, which is located in the lifting device 3, whereupon the first wafer sheet 10 is placed on top of the second wafer sheet 20 that is coated with the food product 30. Reference is had, at this point, to the illustration in FIG. 4.

The conveyor belt 25 then feeds the wafer sheet 40 comprising the two wafer sheets 10 and 20 and the intermediate layer of a food product 30 to the further conveyor belt 45. The latter then transports the wafer sheet 40 to the fourth workstation 4 formed by a unit for pressing the wafer sheet 40.

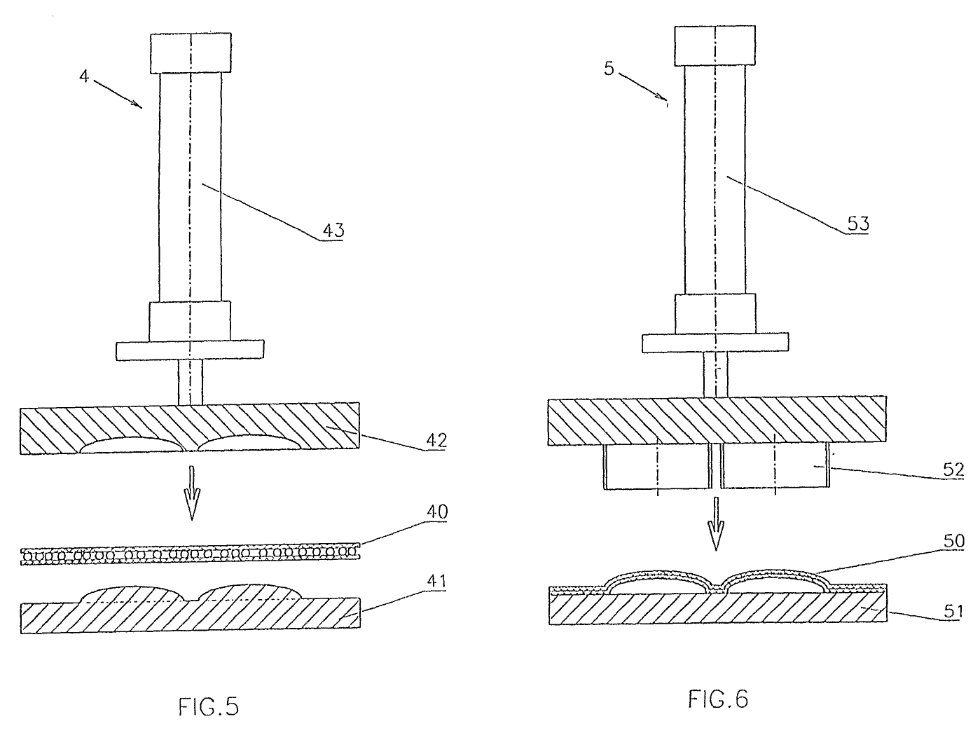

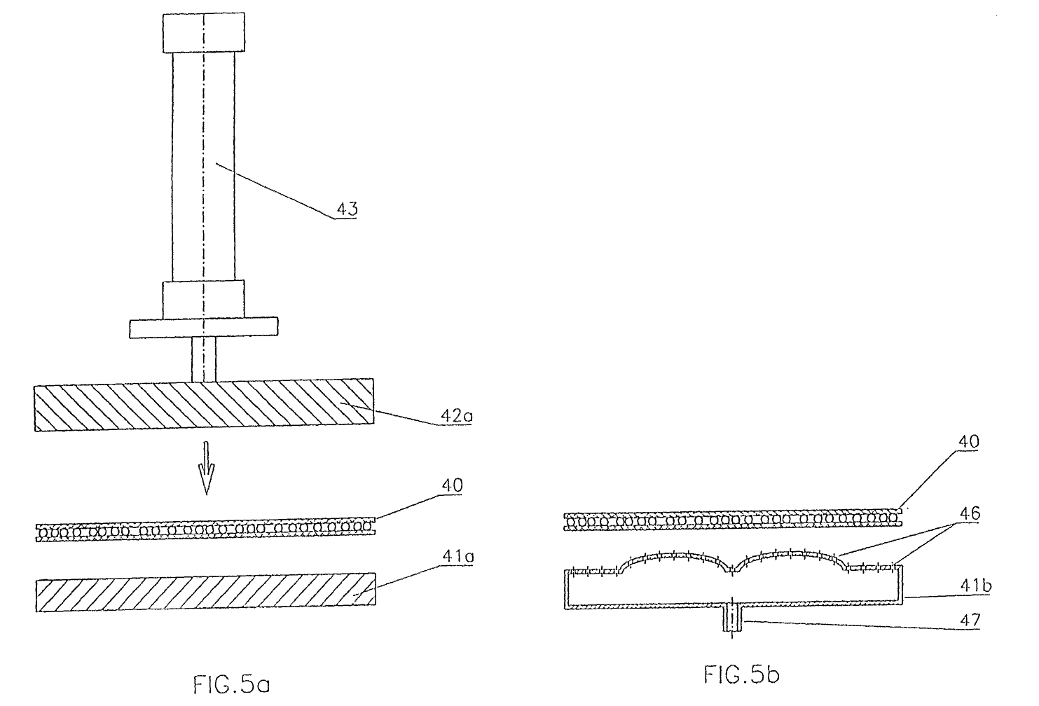

Referring now to FIG. 5, the press device 4 comprises a first profiled press plate 41 and an associated second press plate 42 of a diametrically opposed profile, between which the wafer sheet 40 is located. By lowering the second press plate 42 by means of an actuator 43, the wafer sheet 40 is formed in accordance with the design of the two press plates 41 and 42 and is given, for example, a cup shape. Subsequently, the wafer sheets 50 thus shaped are fed to the fifth workstation 5 depicted in FIG. 6, which is formed by a stamping device. The stamping device 5 comprises a base plate 51, on which wafer sheets 50 are supported, and associated stamping tools 52, which can be moved up and down by an actuator 53. With this stamping device 5 cup-shaped wafer elements 60 are stamped out of the shaped wafer sheets 50, which are discharged by a further conveyor belt 55. These wafer elements 60 can subsequently be filled with a further food product, e.g. with a chocolate cream, sealed by another wafer sheet and coated, for example, with a chocolate layer. According to a variant embodiment, the stamping device 5 merely produces predetermined breaking points in wafer element 40 so that the individual wafer elements 60 can be separated from each other by severing in a subsequent work step.

FIGS. 5a and 5b show variant embodiments of the fourth workstation. FIG. 5a depicts a press device in which the press plates 41a and 42a are flat. FIG. 5b shows a shaping device formed by a hollow body 41b with a profile on one side, the profiled surface of which is provided with suction openings 46 that are adjoined by a suction port 47. The wafer sheet 40 can be aspirated onto this hollow body 41b, which causes it to be likewise profiled.

To ensure that the wafer sheets 10 and 20 in every case retain the elasticity required for shaping for a short time after the baking process, the wafer batter must have a sugar content of at least 23w. Instead of sugar, a substitute with the technological properties of sugar may be used. Trehalose is preferably used for this purpose. It is important for the wafer sheets in the warm state to have sufficiently high elasticity that they can be shaped in the warm state after the baking process. To keep the wafer sheets at the required high temperature, all workstations are located within a sealed enclosure, which is preferably pressurized with hot air. After the shaping process, the products can be cooled, e.g. by supplying cold air.

It is possible, with this process, to produce stacked wafer sheets of any taste category, which can be used to produce any type of wafer products. Since this process furthermore renders it possible to produce wafer sheets of any shape from flat wafer sheets using different press molds without requiring different baking molds, a wide variety of differently shaped wafer products can be produced at little extra cost.

It will be readily understood that, analogously, more than two wafer sheets with interposed layers of food products can also be pressed together and shaped if applicable.

I claim:

1. A method of producing a wafer product, which comprises:
outputting a first wafer sheet with a sugar content of at least 23% or an equivalent content of a substance having the same technological properties as sugar from a baking oven;
applying to the first wafer sheet, while the first wafer sheet is in a hot state, a layer of a food product;
providing a second wafer sheet with a sugar content of at least 23% or an equivalent content of a substance having the same technological properties as sugar, and placing the second wafer sheet, while the second wafer sheet is in a hot state, on the first wafer sheet; and
subsequently compressing and spatially shaping the first and second hot wafer sheets containing the layer of the food product.

2. The method according to claim 1, which comprises placing onto the first wafer sheet a food product selected from the group consisting of a confection, meat product, fish product, cheese product, fruit product, vegetable product, nuts, and almonds.

3. The method according to claim 1, wherein the substance having the same technological properties as sugar is trehalose.

4. The method according to claim 1, which comprises cutting the pressed-together wafer sheets into individual hollow bodies and subsequently introducing a filling into the hollow bodies.

5. The method according to claim 1, which comprises cutting the spatially shaped wafer product into individual wafer products and providing the individual wafer products with an outer coating.

6. The method according to claim 1, which comprises processing, together with the first and second wafer sheets, additional hot wafer sheets with interposed layers of food products.

7. An assembly for producing wafer products according to claim 1, comprising:
an baking oven outputting hot wafer sheets;
a conveyor device adjacent said baking oven;
a lifting device for lifting a respective first wafer sheet of a pair of hot wafer sheets from said conveyor device;
a dosing device for depositing a food product onto a respective second wafer sheet of the pair of hot wafer sheets; and
a processing device disposed to receive the pair of hot wafer sheets for pressing and shaping the two superimposed hot wafer sheets containing the layer of food product.

8. The assembly according to claim 7, wherein said baking oven is an automatically controlled baking oven.

9. The assembly according to claim 7, wherein said processing device is a shaping device.

10. The assembly according to claim 7, wherein said processing device is a suction device.

11. The assembly according to claim 7, which further comprises a separation device configured to divide the combined wafer sheets into individual hollow elements.

12. The assembly according to claim 11, wherein said separation device is a stamping device.

13. A wafer product, comprising a plurality of wafer sheets and intermediate layers of a food product disposed between respective said wafer sheets, combined by pressing and spatially shaped into individual wafer product.
